(19) United States
(12) Patent Application Publication
(10) Pub. No.: US 2014/0267089 A1
(43) Pub. Date: Sep. 18, 2014

(54) Geometric Shape Generation using Multi-Stage Gesture Recognition

(71) Applicant: SHARP LABORATORIES OF AMERICA, INC., Camas, WA (US)

(72) Inventor: Dana S. Smith, Dana Point, CA (US)

(73) Assignee: Sharp Laboratories of America, Inc., Camas, WA (US)

(21) Appl. No.: 13/846,469

(22) Filed: Mar. 18, 2013

(51) Int. Cl. G06F 3/0488

(52) U.S. Cl. CPC G06F 3/04883
USPC 345/173

(57) ABSTRACT

A system and method are provided for generating geometric shapes on a display screen using multiple stages of gesture recognition. The method relies upon a display screen having a touch sensitive interface to accept a first touch input. The method establishes a base position on the display screen in response to recognizing the first touch input being recognized as a first gesture. The touch sensitive interface then accepts a second touch input having a starting point at the base position, and an end point. A geometric shape is interpreted in response to the second touch input being recognized as a second gesture, and the method presents an image of the interpreted geometric shape on the display screen. A human finger, marking device, or both may be used for the touch inputs.

### BACKGROUND OF THE INVENTION

1. Field of the Invention

This invention generally relates to a computer-aided drawing program and, more particularly, to a system and method for using multiple stages of touch interpreted gestures to create computer-generated shapes on a display screen.

2. Description of the Related Art

The use of computer programs, displays, and styli has long been a method to interact with such a computing system to yield drawings, diagrams, and line representations of geometric shapes. Most of these systems require the user to select a tool from a presented tool palette to create regular geometric shapes. That is, to create a rectangle, one first selects a rectangle shape creation mode by clicking or tapping on a button control indicating a rectangle is to be generated, then by for example, clicking and holding a mouse button while dragging a marquee representation. After release, the marquee outline is replaced with visible graphical lines on the boundary of the rectangle.

Similar actions might be accomplished using a stylus or digital writing instrument in place of a mouse, but again, operation is by pre-selecting an ensuing action from a tool palette, and then manipulating a control using the stylus to create the desired shape. The above-mentioned conventional methods for creating regular geometric shapes (circles, rectangles, triangles, etc.) detract from idea flow and creativity by introducing distracting user interface interactions.

It would be advantageous if there was a fast, simple, easy to use, natural gesturing approach to realize a satisfactory result in the creation of geometric shapes.

### SUMMARY OF THE INVENTION

Disclosed herein are a system and method for using fingers and marking objects (i.e. styli) to interact with a display surface, and especially in interactions purposed to draw geometric shapes. These means draw upon the increasing sophistication of touch interface technology on a display panel, and on the capabilities of newer stylus technologies, which allow the simultaneous use of touches from fingers of one hand, and a stylus held in the other, on the surface of the display. In one aspect, locating the position of a fingertip touch establishes a first point, and the tip of the stylus is brought adjacent to the fingertip position, which describes second and subsequent points as the stylus moves away from the first point in some direction. Depending upon later significant changes in direction and/or shape of the stylus trajectory continuation, the underlying system can, by analysis of the combined first point and stylus coordinates over time, generate a specific regular geometric shape. After creation, and outside the above-described method, finger touches may be used to directly manipulate the created graphical object in the manner typically expected, such as scaling, rotating, etc.

These actions avoid unnecessary motions to locate and select a tool from a palette, which then requires variations of drawing or control manipulations to generate the shape. As such, the means described herein represent an improved user experience, particularly if the user wishes to rapidly create several shapes of differing geometry, since a great deal of wasted motion and time is avoided. In other variations affording only the use of a finger touch, or only the use of a stylus touch, a substituted gesture sequence allows the same operability to a user.

Accordingly, a method is provided for generating geometric shapes on a display screen using multiple stages of gesture recognition. The method relies upon a display screen having a touch sensitive interface to accept a first touch input. The method establishes a base position on the display screen in response to recognizing the first touch input being as a first gesture. In one aspect this step is performed by a software application, enabled as a sequence of processor-executable instructions stored in a non-transitory memory. The touch sensitive interface then accepts a second touch input having a starting point at the base position and an end point. A geometric shape is interpreted in response to the second touch input being recognized as a second gesture, and the method presents an image of the interpreted geometric shape on the display screen.

The touch sensitive interface accepts (recognizes) the first and second touch inputs as a result of sensing an object such as a human finger, a marking device, or a combination of a human finger and a marking device. In one aspect using a single object (finger or marking object), the touch sensitive interface accepts the first touch input by sensing a first object performing a first motion. The base position is established in response to the first motion being recognized as a first gesture, and the second gesture is recognized when the first object is re-sensed within a predetermined time and distance from the base position. Alternatively, both a finger and a marking object may be used, so that the touch sensitive interface accepts the first touch input by sensing a particular motion being performed by the first object, or the first object being maintained at a fixed base position with respect to the display screen for a predetermined (minimum) duration of time. Then, the touch sensitive interface accepts the second touch input by sensing a second object at the starting point, which is within a predetermined distance on the display screen from the base position.

Additional details of the above-described method, processor-executable instructions for generating geometric shapes, and a corresponding system for generating geometric shapes using multiple stages of gesture recognition are provided below.

### BRIEF DESCRIPTION OF THE DRAWINGS

FIG. 1 is a schematic block diagram depicting a system for generating geometric shapes on a display screen using multiple stages of gesture recognition.

FIGS. 2A and 2B are diagrams depicting the use of a single object for creating touch sensitive inputs.

FIG. 3 is a diagram depicting a dual object method for creating geometric shapes.

FIG. 4 is a diagram illustrating a second touch input defining a partial geometric shape.

FIGS. 5A through 5I depict a sequence of operations using two distinct marking objects.

FIG. 6 is a flowchart illustration steps in the performance of the method described by FIG. 3.

FIGS. 7A through 7D are a variation of the gesture recognition system using popup menus.

FIG. 8 is a variation of the flowchart presented in FIG. 6, illustrating steps associated with FIGS. 7A through 7D.

FIGS. 9A through 9F depict a sequence of steps in a single object gesture recognition system.

FIG. 10 is a diagram depicting functional blocks of a system enabling the invention through touch sensing, position determination and reporting, gesture recognition, and gesture interpretation.

FIG. 11 is a flowchart illustrating steps associated with the example depicted in FIGS. 9A through 9F.

FIG. 12 is a flowchart illustrating a method for generating geometric shapes on a display screen using multiple stages of gesture recognition.

FIG. 13 is a block diagram depicting processor-executable instructions, stored in non-transitory memory, for generating geometric shapes on a display screen using multiple stages of gesture recognition.

### DETAILED DESCRIPTION

FIG. 1 is a schematic block diagram depicting a system for generating geometric shapes on a display screen using multiple stages of gesture recognition. The system 100 comprises a display screen 102 having a touch sensitive interface, as represented by the display surface 103. There are many available touch sensor technologies, but the market is currently dominated by two technologies. Low cost systems that do not need multi-touch capability often use resistive touch, which measures the resistance of a conductive network that is deformed by touch creating a connection between X and Y bus lines. The most commonly used multi-touch sensing technology, which is referred to as projected capacitive, measures the capacitance between each pair of electrodes in a cross point array. The capacitance of a finger close to the sensor changes the mutual capacitance at that point in the array. Both of these technologies are fabricated independently of the display and are attached to the front of the display causing additional cost, complexity, and some loss of light due to absorption.

The system 100 further comprises a processor 104, a non-transitory memory 106, and a software application 108, enabled as a sequence of processor-executable instructions stored in the non-transitory memory. The system 100 may employ a computer 112 with a bus 110 or other communication mechanism for communicating information, with the processor 104 coupled to the bus for processing information. The non-transitory memory 106 may include a main memory, such as a random access memory (RAM) or other dynamic storage device, coupled to the bus 110 for storing information and instructions to be executed by a processor 104. The memory may include dynamic random access memory (DRAM) and high-speed cache memory. The memory 106 may also comprise a mass storage with one or more magnetic disk or tape drives or optical disk drives, for storing data and instructions for use by processor 104. For a workstation personal computer (PC), for example, at least one mass storage system in the form of a disk drive or tape drive, may store the operating system and application software. The mass storage may also include one or more drives for various portable media, such as a floppy disk, a compact disc read only memory (CD-ROM), or an integrated circuit non-volatile memory adapter (i.e. PC-MCIA adapter) to input and output data and code to and from the processor 104. These memories may also be referred to as a computer-readable medium. The execution of the sequences of instructions contained in a computer-readable medium may cause a processor to perform some of the steps associated with recognizing display screen touch inputs as gestures used in the creation of geometric shapes. Alternately, some of these functions may be performed in hardware. The practical implementation of such a computer system would be well known to one with skill in the art.

The computer 112 may be a personal computer (PC), workstation, or server. The processor or central processing unit (CPU) 104 may be a single microprocessor, or may contain a plurality of microprocessors for configuring the computer as a multi-processor system. Further, each processor may be comprised of a single core or a plurality of cores. Although not explicitly shown, the processor 104 may further comprise co-processors, associated digital signal processors (DSPs), and associated graphics processing units (GPUs).

The computer 112 may further include appropriate input/output (I/O) ports on line 114 for the display screen 102 and a keyboard 116 for inputting alphanumeric and other key information. The computer may include a graphics subsystem 118 to drive the output display for the display screen 102. The input control devices on line 114 may further include a cursor control device (not shown), such as a mouse, touchpad, a trackball, or cursor direction keys. The links to the peripherals on line 114 may be wired connections or use wireless communications.

As noted above, the display screen 102 has an electrical interface on line 114 to supply electrical signals response to touch inputs. When the display screen touch sensitive interface 103 accepts a first touch input, the software application 108 establishes a base position on the display screen in response to recognizing the first touch input as a first gesture. The base position may or may not be shown in the display screen 102. Then, the display screen touch sensitive interface 103 accepts a second touch input having a starting point at the base position, and an end point, and supplies a corresponding electrical signal on line 114. The software application 108 creates a geometric shape, interpreted in response to the second touch input being recognized as a second gesture, and supplies an electrical signal on line 114 to the display screen 102 representing an image of the interpreted geometric shape.

The touch sensitive interface 103 recognizes or accepts the first and second touch inputs in response to sensing an object such as a human finger, a marking device, or a combination of a human finger and a marking device. Note: when two different objects are used to create the first and second touch inputs, the sequence may be a human finger followed by marking device, or marking device followed by a human finger. In some aspects, the two objects may both be marking devices, which may be different or the same. Likewise, it would be possible for the two objects to both be human fingers. The marking devices may be passive, or include some magnetic, electronic, optical, or ultrasonic means of communicating with the touch sensitive interface.

FIGS. 2A and 2B are diagrams depicting the use of a single object for creating touch sensitive inputs. The touch sensitive interface accepts the first touch input in response to sensing a first object 200 performing a first motion 204. The software application establishes the base position 206 in response to the first motion being recognized as a first gesture. Here, the motion 204 is shown as a back-and-forth motion, however, it should be understood a variety of other types of motions may be used to perform the same function. The touch sensitive interface accepts the second touch input in response to re-sensing (reacquiring) the first object 200 prior to the termination of a time-out period beginning with the acceptance of the first touch input. As used herein, the system may be said to “re-sense” the first object even if it continually tracks the first object as it moves from the first touch input to the second touch input. In one aspect, the second touch input starting point 208 must occur with a predetermined distance 202 from the base position 206. In another aspect, the base position and starting point are the same. More detailed examples of the two-object method are presented below.

FIG. 3 is a diagram depicting a dual object method for creating geometric shapes. The touch sensitive interface accepts (recognizes) the first touch input in response to sensing a first object 200 being maintained at a fixed base position 206 with respect to the display screen for a predetermined duration of time (e.g. a minimum duration time). Alternatively, as described in detail above, the first touch input may be recognized in response to the first object performing a particular (first) motion. In general, the recognition of a gesture involves the detection of a touch and recordation of touch location(s) as a function of time, durations, and the nature of the object touching. As such, ‘touch and hold’ may be a gesture in a grammar that include other common ones—‘tap’, ‘double tap’, ‘slide’, ‘swipe’, etc. A specialized gesture may be defined for a particular purpose and recognized within the context of that purpose.

The touch sensitive interface accepts (recognizes) the second touch input starting point in response to sensing the first object being maintained at the base position 206, and sensing a second object 300, different than the first object 200, within a predetermined distance 202 on the display screen from the base position 206. In one aspect, the second touch input must be sensed within a predetermined duration of time beginning with the acceptance to the first touch input.

FIG. 4 is a diagram illustrating a second touch input defining a partial geometric shape. With application to the variations of either FIG. 2A or 3, the touch sensitive interface may accept a second touch input in response to sensing a partial geometric shape defined between the base position 206 and the end point 400. In this aspect, the software application may create a complete geometric shape in response to the second touch input defining the partial geometric shape. In this example, the partial geometric shape is two lines at a right-angle, and the complete geometric shape is a rectangle. Additional examples are provided below.

The above-explained figures describe a novel use of the pairing of a fingertip and a marking device (e.g., a stylus tip) in a system differentiating between the finger and stylus to describe a desired shape with minimal action. The system uses a touch point and a single, continued, or segmented drawing gesture to convey shape intention. For example, the system uses of a touch point and a single, continued, or segmented drawing gesture to enumerate polygon shape side counts in a polygon shape intent. The system may be enabled with only a fingertip or stylus tip interaction capability

FIGS. 5A through 5I depict a sequence of operations using two distinct marking objects. As explained above, the system comprises a processor, memory, and a display surface having the capability to sense touches upon the surface from a fingertip and separately or conjointly, uniquely and identifiably sense touches from a marking device (e.g. writing stylus), and track the positions of both touch classes. As shown in FIG. 5A, a first gesture may be recognized by placing a single fingertip at a location upon the display surface, followed in close temporal proximity by a second gesture initiated by placing a writing stylus tip adjacent to the fingertip (FIG. 5B). The second gesture is completed by first moving the writing stylus in contact with the display surface in a line away from the fingertip location as a drawing gesture (FIG. 5C), and then by changing the direction of drawing with a new polyline segment, at one of several possible angles, and with one or more attributes such as straightness, curvature, or distinguishable additional segments (FIG. 5D). The finalization of the gesture occurs when both the fingertip and writing stylus tip are removed from the display surface.

The data representing the drawn gesture are analyzed to extract the first drawing component, the line representation, and the remainder of the drawn gesture relative to the initial line component. The initial line component indicates a scale to the system which is subject to refinement based upon the analysis of the continuation components of the gesture. That is, if the first drawn component is a line of length L, and the second component an arc segment A, the components together represent to the system a desire to generate a circle having its center at the midpoint of the line and a radius of L/2 (FIG. 5E). Alternatively but not shown, the figure may be interpreted as a circle with a radius of L, with a center at base position 206. In the case of the second component (A) being an arc, adding a third component of a straight line segment by continuing the end of the arc towards the finger position would generate a sector (not shown) rather than a complete circle.

As illustrated below and in other gesture representations, the results of drawing motions and gestures are shown as visibly rendered digital ink. This rendered ink would be removed and replaced by the intended geometric shape, itself rendered in some manner. However, these are variations of desirable cues and feedback to the user, but are optional details non-integral to the system. The execution of the gesture alone, without visible trace, is sufficient for the intended system response based upon the gesture recognition.

It is also possible to render more than one geometric shape on the display screen. After completing the circle of FIG. 5E, a second figure may be added, with the second component of the second touch input being a straight line segment of length M at an approximate 90 degree angle to a first line L (FIG. 5F). The system may interpret the second touch input as a request for a rectangle with a vertex at the fingertip position and a first side of length L and a second side of length M (FIG. 5G).

In the case of the second component being a straight line segment of length M at an approximate 45 degree angle to the first line L, the system may interpret this combination as a request for a right triangle with the 90 degree vertex at the fingertip position and two sides of length L (not shown).

Similarly, if the second component of the second touch input is a straight line segment of length M at an angle θ to the first line L, where θ is either an approximate obtuse or acute angle, the system may interpret this combination as a request for a triangle with a vertex at the fingertip position and a first side of length L and a second side of length M with included angle θ, with remaining side and angles computed from trigonometry (not shown). Although only two geometric shapes have been described above, it should be understood that the system is not limited to any particular number, as any number of additional figures or shapes may be added after the generation of the second shape.

For polygons exceeding four sides, the gesture used to invoke a rectangle is extended. After the second straight line segment of length M at an approximate 90 degree angle to the first line, a short third straight line segment N diverging at a recognizable angle (FIG. 5H) may be interpreted by the system as a request for a quadrilateral with one additional side, i.e. a pentagon (FIG. 5I). Similarly, additional short segments added in a zig-zag manner, or other discriminable abrupt changes of trajectory, add sides to the polygon (not shown). Thus, a fourth segment, O, would indicate a hexagon, a fifth segment, P, a heptagon, and so on. For all these polygons (not shown) the initial line length L may determine an initial scale as the distance between the vertex at the finger position and the opposing, or closest to opposing, vertex.

It is assumed that any regular shape thus created by the system is represented in drawing descriptors that allow subsequent transformations by the user to achieve desired size, rotation, etc.

The specific utilization of the initial line length L to determine an initial scale can also be redefined by the user, such that it may be the diameter of the circumscribed circle of the regular shape. A user could select such interpretations for all created shapes or individualize for specific shapes. For example, for a rectangle L may be a side length, for a right triangle the longer side, for an obtuse triangle the base, and so forth.

Additionally but not shown, the regular shape initial orientation may be related to the orientation of the initial line L, with the first interpretation making the diameter of a created circle parallel to L′, the line fit of L, the second as making the longer side of a right triangle parallel to L′, the longer side of a rectangle parallel to L′, and similar interpretations assigned to other initial shape orientations as logical.

FIG. 6 is a flowchart illustration steps in the performance of the method described by FIG. 3. Step 600 detects and locates a first touch (e.g. finger) input to the display screen, and Step 602 determines the touch hold time, and recognizes the first touch as a first gesture. Step 604 detects and locates a second touch (e.g. stylus) input. Step 606 determines proximity between the first and second touch inputs. If Step 608 determines that a proximity threshold has been passed, Step 610 recognizes the second touch as a second gesture, and Step 612 generates a geometric shape. If the first and second touch inputs fail the proximity determination in Step 608, the gesture recognition process is terminated in Step 614.

FIGS. 7A through 7D are a variation of the gesture recognition system using popup menus. Following the recognition of the first gesture, the system response to the finger touch and pen line segments is to provide a popup menu providing the user with a few options (FIG. 7A) for the subsequent generation of the regular geometric shape (FIG. 7B). These options might at least be whether the shape is outline only or filled, and could easily be extended to other characteristics provided by vector-based computer graphics drawing such as line colors and weights, fill colors and transparency, etc. (FIGS. 7C and 7D).

Additionally, for the case where the second line segment of the second touch input is an arc, it may be simpler for the user to utilize a menu to direct the system to create either a full circle or a sector and establish other characteristics at the same time.

FIG. 8 is a variation of the flowchart presented in FIG. 6, illustrating steps associated with FIGS. 7A through 7D. Step 600 detects and locates a first touch (e.g. finger) input to the display screen, and Step 602 determines the touch hold time, and recognizes the first touch as a first gesture. Step 604 detects and locates a second touch (e.g. stylus) input. Step 606 determines proximity between the first and second touch inputs. If Step 608 determines that a proximity threshold has been passed, Step 610 recognizes the second touch as a second gesture. Step 800 provides a popup window associated with the recognized gesture, and Step 802 manipulates the popup menu to generate a geometric shape. If the first and second touch inputs fail the proximity determination in Step 608, the gesture recognition process is terminated in Step 614.

FIGS. 9A through 9F depict a sequence of steps in a single object gesture recognition system. In another aspect, a first gesture is comprised of placing a single fingertip at a location upon the display surface (FIG. 9A), moving it in a circular motion (FIG. 9B), and lifting the fingertip (FIG. 9C), followed in close temporal proximity by a second gesture initiated by returning the fingertip to the approximate same position (FIG. 9D). The second gesture is completed by moving the fingertip in contact with the display surface in a line away from the fingertip location as a drawing gesture and then by changing the direction of drawing with a new polyline segment, at one of several possible angles and with one or more attributes such as straightness, curvature, or distinguishable additional segments (FIG. 9E). The finalization of the gesture occurs when the fingertip is removed from the display surface (FIG. 9F). Here the object is shown as a fingertip, but alternatively, the object may be a marking object.

FIG. 10 is a diagram depicting functional blocks of a system enabling the invention through touch sensing, position determination and reporting, gesture recognition, and gesture interpretation. The block diagram depicts an exemplary flow among software modules which perform the necessary sensing, data communication, and computations.

FIG. 11 is a flowchart illustrating steps associated with the example depicted in FIGS. 9A through 9F. Step 1100 detects and locates a first touch input to the display screen, and Step 1102 determines the touch change of position during a defined period of time. Step 1104 detects a removal of the touch in spatial proximity to the initially detected position. Step 1106 detects and locates a second touch initial position. If Step 1108 determines that Step 1106 occurs within a predetermined period of time from the recognition of the first touch, the method proceeds to Step 1110 where the spatial proximity of the first and second determines is determined. If Step 1112 determines that a spatial proximity threshold has been passed, Step 1114 recognizes the second touch as a second gesture, and Step 1116 generates a geometric shape. If either the temporal or spatial proximity tests fail, Steps 1118 or 1120 terminate the gesture recognition process.

FIG. 12 is a flowchart illustrating a method for generating geometric shapes on a display screen using multiple stages of gesture recognition. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 1200.

The method begins with Step 1200. In Step 1202 a display screen having a touch sensitive interface accepts a first touch input. In Step 1204 a software application, enabled as a sequence of processor-executable instructions stored in a non-transitory memory, establishes a base position on the display screen in response to recognizing the first touch input being as a first gesture. Note: this base position may or may not be marked on the display screen (seen by the user). In Step 1206 the touch sensitive interface accepts a second touch input having a starting point at the base position, and an end point. The second touch input may or may not be marked on the display screen. In Step 1208 the software application creates a geometric shape that is interpreted in response to the second touch input being recognized as a second gesture. Step 1210 presents an image of the interpreted geometric shape on the display screen.

In one aspect, accepting the second touch input in Step 1206 includes the second touch input defining a partial geometric shape between the base position and the end point, and creating the interpreted geometric shape in Step 1208 includes creating a complete geometric shape in response to the second touch input defining the partial geometric shape.

As noted above, the touch sensitive interface accepts or recognizes the first and second touch inputs, respectively in Steps 1202 and 1206, by sensing an object such as a human finger, a marking device, or a combination of a human finger and a marking device. For example, using just a single object, the touch sensitive interface may sense a first object performing a first motion in Step 1202. Step 1204 establishes the base position in response to the first motion being recognized as a first gesture. Then, Step 1206 accepts the second touch input by re-sensing the first object. More explicitly, Step 1206 may re-sense the first object prior to the termination of a time-out period beginning with the acceptance of the first touch input. In another variation of Step 1206, the touch sensitive input re-senses the first object within a predetermined distance on the touch screen from the first touch input. The method may be said to “re-sense” the first object even if the first object is continually sensed by the display screen touch sensitive interface between the first and second touch inputs.

In another aspect using two objects, Step 1202 accepts the first touch input when the touch sensitive interface senses a first object being maintained at a fixed base position with respect to the display screen for a predetermined duration of time. Alternatively, Step 1202 accepts the first touch input in response to the first object performing a first motion. In Step 1206 the second touch input is accepted when the touch sensitive interface senses a second object, different than the first object, at a starting point within a predetermined distance on the display screen from the base position. In one aspect, Step 1206 senses the first object being maintained at the base position while sensing the second object.

FIG. 13 is a block diagram depicting processor-executable instructions, stored in non-transitory memory, for generating geometric shapes on a display screen using multiple stages of gesture recognition. A communication module 1302 accepts electrical signals on line 1304 from a display screen touch sensitive interface responsive to touch inputs. A gesture recognition module 1306 recognizes a first gesture in response to a first touch input and establishes a base position on the display screen. The gesture recognition module 1306 recognizes the second gesture as having a starting point at the base position and an end point, and a shape module 1308 creates an interpreted geometric shape. Then, the communication module 1302 supplies electrical signals on line 1310 representing instructions associated with the interpreted geometric shape. In one aspect, the instructions represent an image of the interpreted geometric shape that is sent to display screen for visual presentation. Otherwise, the instructions may be sent to an external module, which in turn interprets the instructions in another context, where the instructions convey a meaning associated with, but beyond the description of the geometric shape itself. For example, a rectangle may represent the instruction to return home, or a triangle an instruction to pay a bill. In another aspect, the image is initially sent to the display screen for review and/or modification, and subsequently sent to the external module.

In one aspect, the gesture recognition module 1306 recognizes a second gesture defining a partial geometric shape between the base position and the end point, and the shape module 1308 creates a complete geometric shape interpreted in response to the partial geometric shape.

As noted above, the communication module 1302 accepts touch inputs in response to the display screen touch sensitive interface sensing an object such as a human finger, a marking device, or a combination of a human finger and a marking device. If is single object is used, the gesture recognition module 1306 recognizes a first gesture when a first object is sensed performing a first motion, and establishes the base position. Then, the gesture recognition module 1306 recognizes the second gesture in response to the first object being re-sensed. The gesture recognition module 1306 may recognizes the second gesture in response, to the second touch input occurring prior to the termination of a time-out period beginning with the acceptance of the first touch input. Alternatively or in addition, the gesture recognition module 1306 may recognize the second gesture in response to the second touch input occurring within a predetermined distance on the touch screen from the first touch input.

When two objects are used, the gesture recognition module 1306 recognizes the first gesture in response to a first object performing a first motion, or being maintained at a fixed base position with respect to the display screen for a predetermined duration of time. Then, the gesture recognition module 1306 recognizes the second gesture in response to a second object, different than the first object, being sensed at a starting point within a predetermined distance on the display screen from the base position. In one aspect, the gesture recognition module may recognize the second gesture in response to the first object being maintained at the base position, while sensing the second object.

As used in this application, the terms “component,” “module,” “system,” “application”, and the like may be intended to refer to an automated computing system entity, such as hardware, firmware, a combination of hardware and software, software, software stored on a computer-readable medium, or software in execution. For example, a module may be, but is not limited to being, a process running on a processor, a processor, an object, an executable, a thread of execution, a program, and/or a computer. By way of illustration, an application running on a computing device can be a module. One or more modules can reside within a process and/or thread of execution and a module may be localized on one computer and/or distributed between two or more computers. In addition, these modules can execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

Although FIG. 1 depicts the software application as residing in a computer, separately from the display, it should be understood that motion analysis functions may be performed by a “smart” display. As such, the above-mentioned gesture recognition, or even the shape modules, may be software stored in a display memory and operated on by a display processor.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

A system, method, and software modules have been provided generating geometric shapes on a display screen using multiple stages of gesture recognition. Examples of particular motions, shapes, marking interpretations, and marking objects units have been presented to illustrate the invention. However, the invention is not limited to merely these examples. Although geometric shapes have been described herein, the systems and methods may be used to create shapes that might be understood to be other than geometric. Other variations and embodiments of the invention will occur to those skilled in the art.

We claim:

1. A method for generating geometric shapes on a display screen using multiple stages of gesture recognition, the method comprising:
a display screen having a touch sensitive interface accepting a first touch input;
a software application, enabled as a sequence of processor-executable instructions stored in a non-transitory memory, establishing a base position on the display screen in response to recognizing the first touch input being as a first gesture;
the touch sensitive interface accepting a second touch input having a starting point at the base position, and an end point;
the software application creating a geometric shape, interpreted in response to the second touch input being recognized as a second gesture; and,
presenting an image of the interpreted geometric shape on the display screen.

2. The method of claim 1 wherein the touch sensitive interface accepting the first and second touch inputs includes the touch sensitive interface sensing an object selected from a group consisting of a human finger, a marking device, and a combination of a human finger and a marking device.

3. The method of claim 1 wherein the touch sensitive interface accepting the first touch input includes the touch sensitive interface sensing a first object performing a first motion;
wherein establishing the base position on the display screen includes the software application establishing the base position in response to the first motion being recognized as a first gesture; and,
wherein the touch sensitive interface accepting the second touch input includes the touch sensitive interface re-sensing the first object.

4. The method of claim 3 wherein the touch sensitive interface accepting the second touch input includes the touch sensitive input re-sensing the first object prior to the termination of a time-out period beginning with the acceptance of the first touch input.

5. The method of claim 3 wherein the touch sensitive interface accepting the second touch input includes the touch sensitive input re-sensing the first object within a predetermined distance on the touch screen from the first touch input.

6. The method of claim 1 wherein the touch sensitive interface accepting the first touch input includes the touch sensitive interface sensing a first object enacting an operation selected from a group consisting of being maintained at a fixed base position with respect to the display screen for a predetermined duration of time and performing a first motion; and,
wherein the touch sensitive interface accepting the second touch input having the starting point includes the touch sensitive interface sensing a second object, different than the first object, at the starting point within a predetermined distance on the display screen from the base position.

7. The method of claim 6 wherein the touch sensitive interface accepting the second touch input includes the touch sensitive interface sensing the first object being maintained at the base position while sensing the second object.

8. The method of claim 1 wherein the touch sensitive interface accepting the second touch input having the starting point and the end point includes the second touch input defining a partial geometric shape between the base position and the end point; and,
wherein the software application creating the interpreted geometric shape includes creating a complete geometric shape in response to the second touch input defining the partial geometric shape.

9. Processor-executable instructions, stored in non-transitory memory, for generating geometric shapes on a display screen using multiple stages of gesture recognition, the instructions comprising:
a communication module accepting electrical signals from a display screen touch sensitive interface responsive to touch inputs;
a gesture recognition module recognizing a first gesture in response to a first touch input and establishing a base position on the display screen, the gesture recognition module recognizing a second gesture in response to a second touch input having a starting point at the base position and an end point;
a shape module creating an interpreted geometric shape in response to the recognized gestures; and,
wherein the communication module supplies electrical signals to the display screen representing instructions associated with the interpreted geometric shape.

10. The instructions of claim 9 wherein the communication module accepts touch inputs in response to the display screen touch sensitive interface sensing an object selected from a group consisting of a human finger, a marking device, and a combination of a human finger and a marking device.

11. The instructions of claim 9 wherein the gesture recognition module recognizes the first gesture in response to a first object sensed performing a first motion, and establishes the base position; and,
wherein the gesture recognition module recognizes the second gesture in response to the first object being re-sensed.

12. The instructions of claim 11 wherein the gesture recognition module recognizes the second gesture in response to the second touch input occurring prior to the termination of a time-out period beginning with the acceptance of the first touch input.

13. The instructions of claim 12 wherein the gesture recognition module recognizes the second gesture in response to the second touch input occurring within a predetermined distance on the touch screen from the first touch input.

14. The instructions of claim 9 wherein the gesture recognition module recognizes the first gesture in response to a first object enacting an operation selected from a group consisting of being maintained at a fixed base position with respect to the display screen for a predetermined duration of time and performing a first motion, and then recognizes the second gesture in response to a second object, different than the first object, being sensed at the starting point within a predetermined distance on the display screen from the base position.

15. The instructions of claim 14 wherein the gesture recognition module recognizes the second gesture in response to the first object being maintained at the base position, while sensing the second object.

16. The instructions of claim 9 wherein the shape module accepts the second gesture defining a partial geometric shape between the base position and the end point, and creates a complete geometric shape interpreted in response to the second touch input defining the partial geometric shape.

17. A system for generating geometric shapes on a display screen using multiple stages of gesture recognition, the system comprising:
a display screen having a touch sensitive interface for accepting a first touch input, the display screen having an electrical interface to supply electrical signals responsive to touch inputs;
a processor;
a non-transitory memory;
a software application, enabled as a sequence of processor-executable instructions stored in the non-transitory memory, the software application establishing a base position on the display screen in response to recognizing the first touch input as a first gesture;
wherein the display screen touch sensitive interface accepts a second touch input having a starting point at the base position and an end point, and supplies a corresponding electrical signal; and,
wherein the software application creates a geometric shape, interpreted in response to the second touch input being recognized as a second gesture, and supplies an electrical signal to the display screen representing an image of the interpreted geometric shape.

18. The system of claim 17 wherein the touch sensitive interface accepts first and second touch inputs in response to sensing an object selected from a group consisting of a human finger, a marking device, and a combination of a human finger and a marking device.

19. The system of claim 17 wherein the touch sensitive interface accepts the first touch input in response to sensing a first object performing a first motion;
wherein the software application establishes the base position in response to the first motion being recognized as a first gesture; and,
wherein the touch sensitive interface accepts the second touch input in response to re-sensing the first object, prior to the termination of a time-out period beginning with the acceptance of the first touch input.

20. The system of claim 17 wherein the touch sensitive interface accepts the first touch input in response to sensing a first object enacting an operation selected from a group consisting of being maintained at a fixed base position with respect to the display screen for a predetermined duration of time and performing a first motion; and,
wherein the touch sensitive interface accepts the second touch input starting point in response to sensing the first object being maintained at the base position, and sensing a second object, different than the first object, within a predetermined distance on the display screen from the base position.

21. The system of claim 17 wherein the touch sensitive interface accepts the second touch input in response to sensing a partial geometric shape defined between the base position and the end point; and,
wherein the software application creates a complete geometric shape in response to the second touch input defining the partial geometric shape.
